(19) United States
(12) Patent Application Publication
(10) Pub. No.: US 2005/0238759 A1
(43) Pub. Date: Oct. 27, 2005

(54) Gum base composition and process for preparing gum using the same

(76) Inventors: Jeong Min Yoon, Seoul (KR); Byong Kwon Park, Anyang-si (KR)

Correspondence Address: Anderson Kill & Olick, 1251 Avenue of the Americas, New York, NY, 10020-1182, US

(21) Appl. No.: 11/114,819

(22) Filed: Apr. 26, 2005

(30) Foreign Application Priority Data
Apr. 27, 2004 (KR) 2004-29103

(51) Int. Cl. A23G 3/30

(52) U.S. Cl. 426/4

(57) ABSTRACT

A gum base composition including gelatin and calcium carbonate, or gelatin and talc can provide a hard gum that is stone shaped, that can be softened upon chewing. The present invention also provides a process for preparing a stone gum using the gum base composition.

### TECHNICAL FIELD

The present invention relates to a gum base composition and a process for preparing gum that is stone shaped using the gum base composition. More particularly, the present invention relates to a gum base composition including gelatin and calcium carbonate, or gelatin and talc, which can be made into a hard gum that is stone shaped and can be softened upon chewing, and a process for preparing the gum that is stone shaped using the gum base composition.

### BACKGROUND ART

Generally, gum sticks, circular or oval ball shaped gums, etc. are commercially available. However, gums that are stone shaped have not been developed. Hereinafter, gums that are stone shaped will be referred to as “stone gums” or “stone-like gums”, and it is construed to embrace all of the various forms of amorphous hard gums which, when needed, may be coated with various colors. It is difficult to determine a processing condition for preparation of stone-like hard gums and a gum base composition for the stone-like gums whilst satisfying the specific physical properties of gums so it restricts the development of stone gums.

In general, for preparing gum it is important that the ingredients for gum composition are properly selected and the amounts of the ingredients are properly determined. To prepare stone gum which has a specific texture and shape according to the present invention, a specific gum base composition is required to have a physical property which can be chopped into pieces of gum with a desired shape at a mill. In addition, the shaping (chopping) condition of a gum base and the type of mill are also important factors in the preparation of stone gum. Coating a prepared stone gum with syrup with color can produce a specific-shaped, high-valued gum, which is different to common gums that are stick (flat) or ball shaped.

### DISCLOSURE OF THE INVENTION

Therefore, the present inventors made an effort to find an optimal gum base composition and a properly controlled process condition for preparation of stone gum.

The present invention provides a gum base composition suitable for preparation of stone gum.

The present invention also provides a gum composition for preparation of stone gum and stone gum prepared using the gum composition.

The present invention also provides an appropriate process condition for preparation of stone gum.

### BRIEF DESCRIPTION OF THE DRAWING

FIG. 1 is a picture of stone-like gums which are coated with a syrup.

### BEST MODE FOR CARRYING OUT THE INVENTION

The present invention provides a gum base suitable for the preparation of stone gum, a gum composition including the gum base, and a process for preparing stone gum using the gum composition. As used herein, the term “gum” is intended to embrace all so-called gum products, including chewing gum and bubble gum.

To prepare stone gum according to the present invention, a gum base with a physical property that can be chopped (or cutting randomly) into amorphous pieces of stone-like gums is required, unlike in the preparation of common gums that are stick (flat) or ball shaped.

In order to produce pieces of stone-like gums without the gum being flattened or the edges being collapsed at a mill, it is important to appropriately adjust the physical properties of the gum composition. If the gum composition is excessively hard, the morphology of stone-like gums may be stably maintained but the commodity value of the resulting gum product may be lowered due to the tough texture upon chewing. On the other hand, if a gum composition is excessively soft, a gum with collapsed edges may be produced, instead of a gum with an edge chopped like an amorphous stone. In this regard, to prepare a gum that will soften upon chewing and will be chopped into pieces that are desired shape upon crushing, there is a need to prepare a gum base that is different to the gum base used for the preparation of common gums that are stick (flat) or ball shaped. Therefore, the gum base composition according to the present invention includes gelatin, and calcium carbonate or talc.

The present invention provides a gum base composition which includes 0.1-5.0% by weight (hereinafter referred to as ‘wt %’) of gelatin, 18-25 wt % of calcium carbonate or talc, and other common gum base ingredients.

According to an embodiment of the present invention, a gum base composition includes 10-25 wt % of a vinylacetate resin, 10-25 wt % of an ester gum, 6-14 wt % of petroleum wax, 16-24 wt % of polyisobutylene, 1-5 wt % of a plasticizer, 0.5-4 wt % of an emulsifier, 3-10 wt % of polybutene, 18-25 wt % of calcium carbonate, and 0.1-5 wt % of gelatin.

According to another embodiment of the present invention, a gum base composition includes 10-25 wt % of a vinylacetate resin, 10-25 wt % of an ester gum, 6-14 wt % of petroleum wax, 2-10 wt % of polyisobutylene, 2-10 wt % of a plasticizer, 2-5 wt % of an emulsifier, 5-15 wt % of polybutene, 18-25 wt % of talc, and 0.1-5 wt % of gelatin.

To elevate the commodity value and taste of stone gum, the gum base composition may further include 0.1-5 wt % of a flavoring.

If any of the ingredients of the gum base compositions are not within the above ranges, the resulting stone gum may have undesirable physical properties. In detail, if any of the gum base ingredients are not within the above ranges, processing the gum base into pieces of stone-like gums at a mill may be difficult, or the final gum product may have an excessively tough (hard to chew) or soft (melt when chewing) texture, thus lowering the commodity value.

According to the present invention, in the gum base composition, the vinylacetate resin, the petroleum wax, the ester gum, and the polyisobutylene control the touch and elasticity of a gum product and permit production of a gum base that is harder than a common gum base. The ester gum also serves to facilitate film formation in the preparation of bubble gum. The polybutene allows the gum base to be insoluble in water when it is used with the vinylacetate resin. The polybutene also serves to prevent the gum from melting when mixed with saliva. In addition, the polybutene serves to increase viscosity of a gum base when used alone or in combination with the polyisobutylene.

In the gum base composition according to the present invention, the calcium carbonate and the talc are used alternatively. The calcium carbonate and the talc are used to soften the gum texture and to sufficiently mix the liquid ingredients (plasticizer, emulsifier, etc.) and solid ingredients (resins, waxes, etc.) in the gum base composition.

The calcium carbonate and the talc are used alternatively according to the addition of an acidifier such as citric acid, malic acid, or tartaric acid in the gum preparation. Preferably, calcium carbonate is used in the absence of an acidifier, whereas the talc is used in the presence of an acidifier. For example, with respect to a mint gum, since a mint gum composition does not contain an acidifier, it is preferable to use calcium carbonate. Use of talc in the presence of an acidifier permits the long-term storage of gum.

The gelatin used in the gum base composition of the present invention serves to adjust the hardness of gum so that appropriate elasticity and softness are imparted to the gum upon chewing. Furthermore, the gelatin plays an important role in allowing a gum base to have an appropriate strength for cutting at a mill.

In the gum base composition of the present invention, the plasticizer, the emulsifier, and the flavorings are ingredients commonly contained in a gum base composition and specific examples thereof are well known in the pertinent art. The plasticizer may be triacetine, glycerine fatty acid ester, etc. Triacetine is preferable. The emulsifier may be glycerine fatty acid ester, lecithin, etc. Glycerine fatty acid ester is preferable. The flavorings may be mint oil, various fruit flavors, a coffee flavor, a milk flavor, etc.

In addition, the gum base composition of the present invention may further include additives, such as a pigment and a concentrated fruit juice, to impart an appetizing or visual effect for a gum product. The types and contents of these additives can be easily determined by a person skilled in the pertinent art.

According to the present invention, a gum composition includes a gum base prepared using the above-described gum base composition, and other common gum ingredients such as starch syrup, a sweetener, gelatin, a flavoring, and an acidifier. The gum composition according to the present invention may further include 5-15 wt % of glucose. The starch syrup may be a common syrup such as sorbitol syrup or maltitol syrup, the sweetener may be sugar, xylitol powder, etc., and the flavoring may be a common flavoring such as a fruit flavoring, mint flavoring, etc. The acidifier may be an acidic material used as a food additive such as citric acid, malic acid, or tartaric acid.

According to an embodiment of the present invention, a gum composition includes 20-35 wt % of the gum base of the present invention, 50-70 wt % of a sweetener, 1-10 wt % of a starch syrup, 0.1-1 wt % of gelatin, and 0.5-5 wt % of a flavoring.

According to another embodiment of the present invention, a gum composition includes 20-35 wt % of the gum base of the present invention, 50-70 wt % of a sweetener, 1-15 wt % of glucose, 0.5-5 wt % of an acidifier, 1-10 wt % of a starch syrup, 0.1-1 wt % of gelatin, and 0.5-5 wt % of a flavoring.

If any of the ingredients in the gum composition are not within the above ranges, the stone gum produced may have undesirable physical properties. In detail, if any of the gum ingredients are not within the above ranges, the processing of the gum into pieces of stone-like gums at the mill may be difficult, or the final gum product may have an undesirably tough, or soft and melting texture when chewed.

The content of each gum ingredient can be adjusted according to the characteristics of the gum being produced. For example, a bubble gum composition contains 1-15 wt % of glucose to impart softness and elasticity to the bubble gum. On the other hand, a chewing gum composition contains a higher amount of sweetener to allow the sweetener to serve as a filler ensuring sufficient mixing of gum ingredients. In this context, chewing gum is construed to mean a conventional gum not including a bubble gum.

In the preparation of bubble gum, the amount of glucose is 1-15 wt % to facilitate film formation when mixed with a bubble gum base. Unlike in the preparation of bubble gum, glucose is not used in the preparation of chewing gum.

To maintain appropriate strength and physical properties at the mill, a gum base composition includes gelatin of 0.1-5.0 wt % whereas a gum composition includes gelatin of 0.1-1 wt %.

The present invention also provides a process condition suitable for preparation of a gum base.

A vinylacetate resin, an ester gum, and polyisobutylene are placed in a reactor and heated at 110-130° C., with steam, for 10-15 hours. Then, calcium carbonate or talc is added thereto and the reaction mixture is gradually heated. When the temperature of the mixture in the reactor reaches 120-170° C., gelatin is added, uniformly mixed for 1-3 hours, rapidly cooled to 60-70° C., and again uniformly mixed for 1-2 hours. Then, a plasticizer, an emulsifier, and a petroleum wax are added to the reactor and uniformly mixed. Polybutene and a flavoring are then added thereto and uniformly stirred at 110-130° C. for 1-2 hours to produce a gum base.

The gum base thus produced is flattened with a thickness of 5-15 mm, aged at a temperature of 15-25° C. and in a relative humidity (RH) of 40-60% for about 24 to 48 hours, cut into pieces of stone-like gum, and then a stone gum is produced.

More specifically, prior to cutting, the gum base is allowed to pass through a roller to flatten the gum. At this time, the thickness of the flattened gum is not particularly restricted but may be within the range of 5-15 mm.

The pre-formed flattened gum is subjected to aging. The aging is performed at a temperature of 15 to 25° C. and in RH of 40 to 60% for 24 to 48 hours. Through the aging process, the final gum product can have a uniform texture and the flattened gum can be cut into the desired pieces of stone-like gum. Preferably, the aged gum has a hardness of 10-30 kgf/cm². The aged gum is cut into pieces of stone-like gums at a mill.

At this time, it is preferable to use a mill equipped with blades attached to a rotary shaft to cut the target material into the desired pieces, rather than to use a hammer mill to crush target material such as that used for candy. Here, intervals of each blade of the mill and the rotation speed of the rotary shaft to which the mill is attached can be changed according to the size of the gum to be produced. However, it is most preferable that the blade spacing is 2-10 mm, and the rotation speed of the rotary shaft is 40-80 rpm.

Upon cutting, it is preferable to adjust the working temperature and RH to be within a range from 10 to 20° C. and from 30 to 50%, respectively.

After the cutting step, pieces of stone-like gums are placed in a coating fan that has been set to a temperature of 15-20° C. and RH of 30-50%. The coating fan is subjected to no-load rotation at a speed of 15-25 rpm for 30 minutes to 1 hour to maintain the pieces of stone-like gum at a uniform temperature and in a uniform humidity.

Finally, the pieces of stone-like gum may be coated with syrups of various colors to increase the commodity value. For coating with syrup with colors, it is preferable that the amount of syrup with colors used is 20 to 40 wt % based on 80 to 60 wt % of the pieces of stone-like gum. Here, a common syrup with colors may be used with a sugar content of 50-70° Brix which is prepared by heating sugar, starch, gelatin, titanium dioxide, Carnauba wax, and an edible pigment with water. The type of edible pigment and the preparation process for the syrup with color is well known in the pertinent art. The edible pigment and the syrup with color commonly used in production of chocolate or confectionery may be used.

The blow scale of the coating fan is adjusted so that the pieces of the stone-like gum are uniformly coated with the syrup with colors. At the initial stage, the blow capacity and velocity of the coating fan are maintained at 50-100 CMM (m³/min) and 10-20 m/sec, respectively. When the pieces of stone-like gum stuck together by the syrup with color begin to be separated from each other by blowing, the blow capacity and velocity of the coating fan are increased to 100-200 CMM and 20-40 m/sec, respectively. The blowing is initiated when the pieces of stone-like gum are completely coated with the syrup with color. At this time, the blowing is initiated lightly at a blow capacity and velocity of 10-20 m/sec and 50-100 CMM, respectively, and then terminated at an increased blow capacity and velocity of 20-40 m/sec and 100-200 CMM, respectively. The rotation speed of the coating fan is maintained at 15-25 rpm. An increase in the rotation speed of the coating fan can shorten the coating time but the coating on gum edges may be poor. On the other hand, reduction in the rotation speed of the coating fan may retard the coating time and cause of the pieces of stone-like gum to stick together.

When the pieces of stone-like gum have a desired coating thickness through repetition of the above coating process, they are removed from the coating fan and stored in conditions with a temperature of 15-20° C. and RH of 30-50% for 1-2 hours to accomplish a moisture equilibrium. In this state, the resultant gum product may be coated with Carnauba wax of 0.01-0.1 parts by weight based on 100 parts by weight of the gum product for 30 minutes to 1 hour to impart gloss to the gum product.

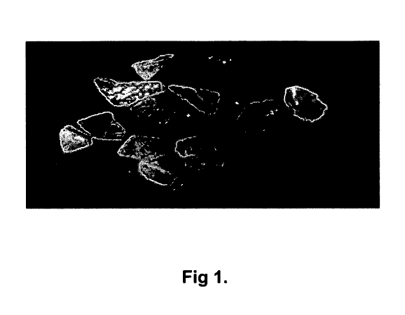

Stone-like gum produced according to the present invention is shown in FIG. 1. The size of a piece of the stone-like gum is not particularly restricted and may be controlled as needed.

Hereinafter, the present invention will be described more specifically with reference to the following examples. The following examples are for illustrative purposes and are not intended to limit the scope of the invention.

### EXAMPLES

### Example 1

### Preparation of Gum Base

20 g of a vinylacetate resin, 15 g of an ester gum, and 20 g of polyisobutylene were placed in a reactor, gradually heated to 120° C., and maintained at that temperature, with steam, for 10 hours. Then, 20 g of calcium carbonate was added thereto and gradually heated. When the temperature of the reaction mixture reached 150° C., 2 g of gelatin was added to the reaction mixture and uniformly mixed for 2 hours. Then, the reaction mixture was rapidly cooled to 60° C. and again uniformly mixed for 2 hours. Then, 3 g of triacetine, 3 g of glycerine fatty acid ester, and log of petroleum wax were added to the reaction mixture and uniformly mixed. Then, 5 g of polybutene and 2 g of mint oil as a flavoring were added to the reaction mixture and uniformly stirred at 120° C. for 2 hours to obtain a gum base A.

Gum bases B through I were prepared in the same manner as described above according to the gum base compositions outlined in Table 1 below. In Table 1, the unit for the content of each ingredient is grams (g).

TABLE 1

| | Gum Base | | | | | | | | |
|---|---|---|---|---|---|---|---|---|---|
| | A | B | C | D | E | F | G | H | I |
| Vinylacetate | 20 | 20 | 20 | 20 | 20 | 20 | 20 | 20 | 20 |
| resin | | | | | | | | | |
| Ester gum | 15 | 15 | 15 | 15 | 15 | 15 | 15 | 15 | 15 |
| Polyisobutylene | 20 | 20 | 20 | 20 | 20 | 20 | 20 | 20 | 20 |
| Calcium | 20 | — | — | 20 | — | 40 | 10 | — | — |
| carbonate | | | | | | | | | |
| Talc | — | 20 | — | — | 20 | — | — | 40 | 10 |
| Gelatin | 2 | 2 | 2 | — | — | 2 | 2 | 2 | 2 |
| Triacetin | 3 | 3 | 3 | 3 | 3 | 3 | 3 | 3 | 3 |
| Glycerin fatty | 3 | 3 | 3 | 3 | 3 | 3 | 3 | 3 | 3 |
| acid ester | | | | | | | | | |
| Petroleum wax | 10 | 10 | 10 | 10 | 10 | 10 | 10 | 10 | 10 |
| Polybutene | 5 | 5 | 5 | 5 | 5 | 5 | 5 | 5 | 5 |
| Flavoring | 2(a) | 2(b) | 2(a) | 2(a) | 2(b) | 2(a) | 2(a) | 2(b) | 2(b) |

(a)Mint oil
(b)Apple flavor

### Example 2

### Preparation of Gum

7 g of sorbitol syrup, 60 g of powdered sugar as a sweetener, 2 g of a flavoring, and 0.5 g of gelatin were added to 30 g of gum base A prepared in Example 1. The resultant mixture was allowed to pass through a roller to be flattened the gum to a thickness of 10 mm. The flattened gum was aged at room temperature (25° C.) and in RH of 40% for 24 hours and cut into pieces of amorphous stone-like gum at the mill. At this time, the roll mill equipped with blades was used with the intervals of each blade being 5 mm and the rotation speed being 60 rpm. The cutting was performed at a temperature of 20° C. and in RH of 40%. The pieces of stone-like gum were placed in a coating fan and coated with 50 g of syrup with colors having a sugar content of 60° Brix prepared by heating the sugar, starch, gelatin, titanium dioxide, Carnauba wax, and an edible pigment with water. The coated gum was removed from the coating fan and stored at an ambient temperature of 20° C. and in RH of 40% for 2 hours. Then, the resultant gums were mixed with 0.05 g of Carnauba wax to impart gloss to the gum, to thereby complete gum product A.

Since gum product A was produced as a chewing gum, glucose was not used, unlike bubble gum requiring bubble film formation. However, in preparation of gum product B which is used as bubble gum, 5 g of glucose and 2 g of citric acid as an acidifier were used to facilitate the bubble formation.

Gums B through I were prepared in the same manner as described above according to the gum ingredients and their content as given in Table 2 below. In Table 2, the unit for the content of each ingredient is grams (g).

TABLE 2

| | Gum | | | | | | | | |
|---|---|---|---|---|---|---|---|---|---|
| | A | B | C | D | E | F | G | H | I |
| Gum | 30(A) | 30(B) | 30(C) | 30(D) | 30(E) | 30(F) | 30(G) | 30(H) | 30(I) |
| base | | | | | | | | | |
| Sorbitol | 7 | 7 | 7 | 7 | 7 | 7 | 7 | 7 | 7 |
| syrup | | | | | | | | | |
| Sugar | 60 | 60 | 60 | 60 | 60 | 60 | 60 | 60 | 60 |
| Gelatin | 0.5 | 0.5 | 0.5 | 0.5 | 0.5 | 0.5 | 0.5 | 0.5 | 0.5 |
| Flavor- | 2 | 2 | 2 | 2 | 2 | 2 | 2 | 2 | 2 |
| ing | | | | | | | | | |
| Glucose | | 5 | | | 5 | | | 5 | 5 |
| Citric | | 2 | | | 2 | | | 2 | 2 |
| acid | | | | | | | | | |

The hardnesses of gum products A through I were measured by a rheometer and the results are presented in Table 3 below.

TABLE 3

| | Gum | | | | | | | | |
|---|---|---|---|---|---|---|---|---|---|
| | A | B | C | D | E | F | G | H | I |
| Hardness(kg/m²) | 17 | 15 | 8 | 23 | 24 | 7 | 9 | 7 | 9 |

Generally, the hardness of gum suitable for chewing is 10-20 kg/cm². If the hardness of gum is less than 10 kg/cm², the gum texture may get soft. On the other hand, if it exceeds 20 kg/cm², the commodity value may be lowered due to excessive hardness. Gums A and B produced according to the present invention, exhibited a hardness of 10 to 20 kg/cm² which is within an appropriate gum hardness range. Therefore, it is considered that gums A and B have hardness suitable for chewing. However, gum C in which calcium carbonate or talc was not added to the gum base composition, gums G and I in which calcium carbonate or talc was added in an amount less than the desired level, and gums F and H in which calcium carbonate or talc was added in an amount above the desired level, softened excessively. Gums D and E, in which no gelatin was used, exhibited a very high hardness, thereby decreasing the commodity value.

The appearances of gums A through I were also observed. According to the observation results, gums A and B, according to the present invention, exhibited stone-like textures due to appropriate cutting as shown in FIG. 1, whereas gums C through I exhibited collapsed edges which were different to the stone-like textures.

1. A gum base composition comprising 10-25 wt % of a vinylacetate resin, 10-25 wt % of an ester gum, 18-25 wt % of calcium carbonate, 6-14 wt % of petroleum wax, 16-24 wt % of polyisobutylene, 1-5 wt % of a plasticizer, 0.5-4 wt % of an emulsifier, 3-10 wt % of polybutene, and 0.1-5 wt % of gelatin.

2. The gum base composition of claim 1, which further comprises 0.1-5 wt % of a flavoring.

3. A gum base composition comprising 10-25 wt % of a vinylacetate resin, 10-25 wt % of an ester gum, 18-25 wt % of talc, 6-14 wt % of petroleum wax, 2-10 wt % of polyisobutylene, 2-10 wt % of a plasticizer, 2-5 wt % of an emulsifier, 5-15 wt % of polybutene, and 0.1-5 wt % of gelatin.

4. The gum base composition of claim 3, which further comprises 0.1-5 wt % of a flavoring.

5. A gum composition comprising 20-35 wt % of a gum base prepared by mixing 10-25 wt % of a vinylacetate resin, 10-25 wt % of an ester gum, 18-25 wt % of calcium carbonate, 6-14 wt % of petroleum wax, 16-24 wt % of polyisobutylene, 1-5 wt % of a plasticizer, 0.5-4 wt % of an emulsifier, 3-10 wt % of polybutene, and 0.1-5 wt % of gelatin; 50-70 wt % of a sweetener; 1-10 wt % of a starch syrup; 0.1-1 wt % of gelatin; and 0.5-5 wt % of a flavoring.

6. A gum composition comprising 20-35 wt % of gum base prepared by mixing 10-25 wt % of a vinylacetate resin, 10-25 wt % of an ester gum, 18-25 wt % of talc, 6-14 wt % of petroleum wax, 2-10 wt % of polyisobutylene, 2-10 wt % of a plasticizer, 2-5 wt % of an emulsifier, 5-15 wt % of polybutene, and 0.1-5 wt % of gelatin; 50-70 wt % of a sweetener; 1-10 wt % of a starch syrup; 1-15 wt % of glucose; 0.5-5 wt % of an acidifier; 0.1-1 wt % of gelatin; and 0.5-5 wt % of a flavoring.

7. A process for preparing a gum base, the process of which comprises:
(a) mixing a vinylacetate resin, an ester gum, and polyisobutylene at a temperature of 110 to 130° C.;
(b) adding calcium carbonate or talc to the resultant mixture of (a) followed by gradual heating;
(c) adding gelatin to the resultant mixture of (b) when the reaction temperature reaches 120 to 170° C.;
(d) rapidly cooling the resultant mixture of (c) to a temperature of 60 to 70° C.; and
(e) adding a plasticizer, an emulsifier, petroleum wax, polybutene, and/or a flavoring to the resultant mixture of (d) followed by mixing at 110 to 130° C.

8. A process for preparing a gum comprising the steps of adding one or more selected from the group consisting of a starch syrup, a sweetener, an acidifier, a flavoring, gelatin, and glucose to the gum base obtained according to the process of claim 7, pre-forming the mixture to a flattened shape, cutting it into pieces that are the shape of stones, and obtaining stone gum.

9. The process for preparing the gum of claim 8, wherein the pre-form that is flattened has a thickness of 5-15 mm.

10. The process for preparing the gum of claim 8, wherein the cutting step is carried out by a mill equipped with blades attached to a rotary shaft, under a temperature of 10-20° C. and in a relative humidity of 30-50%.

11. The process for preparing the gum of claim 8, which further comprises aging the pre-formed gum at a temperature of 15-25° C. and in a relative humidity of 40-60% for about 24 to 48 hours, after pre-forming the mixture.

12. The process for preparing the gum of claim 8, which further comprises coating the gum pieces with syrup with color at a temperature of 15-20° C. and a relative humidity of 30-50% after the cutting step.

13. The process for preparing the gum of claim 12, wherein the coating step is carried out by mixing 20 to 40 wt % of syrup with colors and 80 to 60 wt % of the gum pieces, initially blowing the mixture with a blow capacity of 50-100 CMM (m³/min) and a blow velocity of 10-20 m/sec, and then gradually increasing the blow capacity to 100-200 CMM and the blow velocity to 20-40 m/sec.

14. The process for preparing the gum of claim 12, which further comprises glossing the surface of the gum product by coating it with carnauba wax of 0.01-0.1 parts by weight based on 100 parts by weight of the gum product.
